(19) United States
(12) Patent Application Publication
(10) Pub. No.: US 2025/0377452 A1
(43) Pub. Date: Dec. 11, 2025

(54) COMPRESSIVE IMPLICIT RADAR FOR HIGH-ACCURACY MILLIMETER WAVE IMAGING

(71) Applicant: William Marsh Rice University, Houston, TX (US)

(72) Inventors: Sean M. Farrell, Houston, TX (US); Vivek Boominathan, Houston, TX (US); Nathaniel Raymondi, Houston, TX (US); Ashutosh Sabharwal, Houston, TX (US); Ashok Veeraraghavan, Houston, TX (US)

(73) Assignee: William Marsh Rice University, Houston, TX (US)

(21) Appl. No.: 19/232,598

(22) Filed: Jun. 9, 2025

Related U.S. Application Data
(60) Provisional application No. 63/658,218, filed on Jun. 10, 2024.

(51) Int. Cl. G01S 13/89; G01S 7/35; G01S 7/41; G01S 13/00

(52) U.S. Cl. CPC G01S 13/89; G01S 7/354; G01S 7/356; G01S 7/417; G01S 13/003

(57) ABSTRACT

Methods and systems are disclosed. The method includes obtaining one or more time-domain beat signals. The method further includes generating an under-sampled measured radar data cube based on the one or more time-domain beat signals, and determining, using a computer processor and a machine learning model, an initial scene reflectivity distribution image based on the under-sampled measured radar data cube. The method further includes synthesizing, using the computer processor, the initial scene reflectivity distribution image to obtain a synthetized full radar data cube, and processing, using the computer processor, the synthetized full radar data cube to obtain an under-sampled radar data cube. The method further includes determining, using the computer processor and the machine learning model, an enhanced scene reflectivity distribution image based on a loss function measuring a mismatch of the under-sampled radar data cube and the under-sampled measured radar data cube.

### STATEMENT REGARDING FEDERALLY SPONSORED RESEARCH

This invention was made with government support under Grant Nos. 1956297, 2107313, 2215082, and 1652633 awarded by the National Science Foundation. The government has certain rights in the invention.

### BACKGROUND

Using millimeter wave (mmWave) signals for imaging has an important advantage in that they can penetrate through poor environmental conditions such as fog, dust, and smoke that severely degrade optical-based imaging systems. However, mmWave radars, contrary to cameras and LiDARs, suffer from low angular resolution because of small physical apertures and conventional signal processing techniques. Sparse radar imaging, on the other hand, can increase the aperture size while minimizing the power consumption and read out bandwidth. Therefore, there exists a need to achieve low-cost, high-resolution mm Wave radar imaging using a reduced number of antennas.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method. The method includes obtaining one or more time-domain beat signals, where the one or more time-domain beat signals are obtained from an antenna array that includes a sparse multiple-input multiple-output (MIMO) linear array. The method further includes generating an under-sampled measured radar data cube based on the one or more time-domain beat signals. The method further includes determining, using a computer processor and a machine learning model, an initial scene reflectivity distribution image based on the under-sampled measured radar data cube. The method further includes synthesizing, using the computer processor, the initial scene reflectivity distribution image to obtain a synthetized full radar data cube. The method further includes processing, using the computer processor, the synthetized full radar data cube to obtain an under-sampled radar data cube. The method further includes determining, using the computer processor and the machine learning model, an enhanced scene reflectivity distribution image based on a loss function measuring a mismatch of the under-sampled radar data cube and the under-sampled measured radar data cube.

Embodiments disclosed herein generally relate to a system. The system includes a millimeter wave imaging sensor with optical access to a scene, where the millimeter wave imaging sensor includes an antenna array. The system further includes a machine learning model, where the machine learning model receives an under-sampled measured radar data cube and outputs an enhanced scene reflectivity distribution image. The system further includes a computer communicably connected to the millimeter wave imaging sensor. The computer includes a processor and a memory storing instructions. The instructions, when executed by the processor, cause the processor to obtain one or more time-domain beat signals, where the one or more time-domain beat signals are obtained from the antenna array, and where the antenna array includes a sparse multiple-input multiple-output (MIMO) linear array. The instructions, when executed by the processor, further cause the processor to generate the under-sampled measured radar data cube based on the one or more time-domain beat signals. The instructions, when executed by the processor, further cause the processor to determine, using the machine learning model, an initial scene reflectivity distribution image based on the under-sampled measured radar data cube. The instructions, when executed by the processor, further cause the processor to synthesize the initial scene reflectivity distribution image to obtain a synthetized full radar data cube. The instructions, when executed by the processor, further cause the processor to process the synthetized full radar data cube to obtain an under-sampled radar data cube. The instructions, when executed by the processor, further cause the processor to determine, using the machine learning model, the enhanced scene reflectivity distribution image based on a loss function measuring a mismatch of the under-sampled radar data cube and the under-sampled measured radar data cube.

Embodiments disclosed herein generally relate to a non-transitory computer readable medium storing instructions executable by a computer processor. The instructions, when executed by the processor, cause the processor to obtain one or more time-domain beat signals, where the one or more time-domain beat signals are obtained from an antenna array, and where the antenna array includes a sparse multiple-input multiple-output (MIMO) linear array. The instructions, when executed by the processor, further cause the processor to generate an under-sampled measured radar data cube based on the one or more time-domain beat signals. The instructions, when executed by the processor, further cause the processor to determine, using a machine learning model, an initial scene reflectivity distribution image based on the under-sampled measured radar data cube. The instructions, when executed by the processor, further cause the processor to synthesize the initial scene reflectivity distribution image to obtain a synthetized full radar data cube. The instructions, when executed by the processor, further cause the processor to process the synthetized full radar data cube to obtain an under-sampled radar data cube. The instructions, when executed by the processor, further cause the processor to determine, using the machine learning model, an enhanced scene reflectivity distribution image based on a loss function measuring a mismatch of the under-sampled radar data cube and the under-sampled measured radar data cube.

### BRIEF DESCRIPTION OF DRAWINGS

FIGS. 1A and 1B depict a sparse Multiple-Input Multiple-Output (MIMO) array, a received beat signal, a measured radar data cube, and a millimeter wave imaging sensor, in accordance with one or more embodiments.

FIGS. 2A and 2B depict a comparison of different MIMO virtual array designs in accordance with one or more embodiments.

FIG. 3 depicts a flowchart in accordance with one or more embodiments.

FIGS. 4A and 4B depict a convolutional neural network (CNN) decoder in accordance with one or more embodiments.

FIG. 5 depicts a neural network in accordance with one or more embodiments.

FIGS. 6A and 6B depict experimental results with different sparse MIMO array designs for two outdoor scenes, in accordance with one or more embodiments.

FIGS. 7A and 7B depict experimental results for two different scenes in accordance with one or more embodiments.

FIGS. 8A-8E depict experimental results for varying outdoor scenes in accordance with one or more embodiments.

FIG. 9 depicts image reconstructions for a single outdoor experimental scene using different architectures, in accordance with one or more embodiments.

FIG. 10 depicts results for simulated scenes in accordance with one or more embodiments.

FIGS. 11A-11C depict simulated sparse radar imaging results with additive noise in accordance with one or more embodiments.

FIG. 12 depicts a flowchart in accordance with one or more embodiments.

FIG. 13 depicts a computing system, in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “time-domain beat signal” may include any number of “time-domain beat signals” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

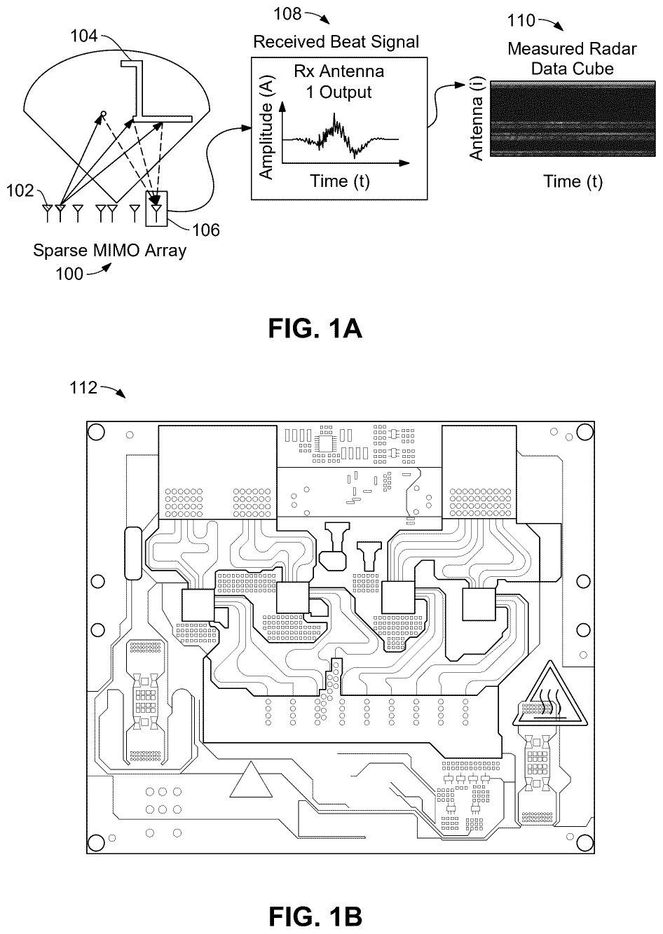

In the following description of FIGS. 1-13, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Depth imaging is a crucial component in many applications, such as simultaneous localization and mapping (SLAM), advanced driver assistance systems (ADAS), security monitoring, and autonomous robots. Typically, these depth imaging applications are accomplished using a combination of visual cameras, LiDAR, and inertial sensors. Visual cameras provide a high angular resolution image of the environment that can be used for near-field dense depth imaging with stereo systems or monocular depth estimation algorithms. LiDARs directly output a dense point cloud of the environment with high range and angular resolutions. However, since visual cameras and LiDARs operate at optical wavelengths, their depth estimation performance is significantly reduced in visually degraded environments containing low light, fog, smoke, snow, and dust. These natural occurrences are especially problematic for depth imaging applications that involve robot and human interactions, such as disaster relief and autonomous self-driving scenarios.

Another depth sensing modality commonly used is millimeter wave (mmWave) radar. Since these radars operate at millimeter wavelengths, they can penetrate through environments with airborne particles common in fog and smoke without significant performance degradation. Additionally, recent availability of low-cost and low-power single chip 77-81 GHz RF bandwidth radars make these devices favorable for integration into low form-factor and power-constrained systems. The main limitation of using single chip mmWave radars for depth imaging is their low angular resolution, which is a function of the operating wavelength (2) and aperture size. As the angular resolution increases, the level of detail in the mmWave image decreases (i.e., it loses the ability to resolve high-frequency information). While deep learning methods have been developed to increase the imaging resolution of mmWave radars, these approaches require large training data sets, which can be challenging to acquire, and have limited generalizability.

Embodiments disclosed herein describe a new process to potentially achieve low-cost, high-resolution millimeter wave radar imaging by co-designing a sparse multi-input multi-output (MIMO) array and novel implicit neural network architecture tailored for radar imaging. Specifically, disclosed herein are embodiments that introduce a compressive large aperture radar imaging (Compressive Implicit Radar or CoIR) system that uses a fraction of the number of antennas but achieves an equivalent resolution to a conventional large aperture radar system. The proposed approach drastically reduces the data bandwidth and leverages implicit neural networks to perform high-accuracy radar imaging from the sparse measurements. In addition, the approach overcomes the aforementioned limitations by being data set agnostic.

Essential to its success is the analysis by synthesis method that leverages the implicit neural network bias in convolutional decoders and compressed sensing to perform high accuracy sparse radar imaging. An analysis by synthesis method is an approach in which interpreting data is achieved by generating a simulated version of that data using a model and then refining the model based on how well the simulated data matches the actual input. The process involves synthesizing data from a hypothesis or model, comparing it with observed data, and updating the model to reduce the difference. This iterative refinement continues until the synthesized output closely approximates the real data, revealing the underlying structure. Embodiments disclosed herein address one of the main limitations of analysis by synthesis methods, that is, slow inference times, by proposing novel initializing strategies for the implicit neural network. A 5× speed up in inference times is demonstrated compared to using random initialization.

Additionally, the proposed system uses commercially available radar chips operating at 77-81 GHz and requires 5.5× fewer antenna elements compared to conventional MIMO array radar designs. As such, methods and systems described herein lower power consumption, decrease manufacturing costs, ease calibration, and lower read out bandwidth (75×) compared to conventional mmWave radars.

The proposed methods and systems consist of two components: 1) a sparse MIMO array design that allows for a 5.5× reduction in the number of antenna elements needed compared to conventional MIMO array designs used commercially, and 2) a fully convolutional implicit neural network architecture tailored for radar imaging that enhances radar imaging accuracy without requiring a training data set. During inference, raw time domain data from the sparse MIMO radar is stored. The untrained neural network is queried and generates an estimated image of the scene. The estimated image is converted to synthesized radar time-domain data using a physics-inspired forward model. A loss is computed between the measured and synthetized time domain radar data. This loss is then backpropagated to update the weights of the neural network. The method is optimized for 2000 iterations (˜40 sec) until convergence is reached. The output from the neural network after the optimization is a high-resolution (i.e., enhanced) radar image of the scene.

The proposed methods and systems of this disclosure are illustrated for 2D millimeter wave radar imaging. However, the framework described herein can be potentially applied to fields such as ultrasound medical imaging or seismic imaging. Additionally, the disclosed method can be extended to 3D and 4D imaging by using a 2D antenna array and sending multiple chirps to extract Doppler velocity information. Further, the proposed system may help transform single chip radars into perceptual depth imaging devices. Thus, the proposed methods and systems could be integrated into autonomous vehicle collision avoidance systems, security monitoring technologies, and non-destructive testing services for inventory inspection in warehouse scenarios. Additionally, as wireless communication systems (e.g., 5G NR) move to millimeter wave frequencies, the methods and systems disclosed herein can be potentially integrated into these systems to allow for user tracking/localization and smart scheduling. One with ordinary skill in the art will appreciate that many more examples exist and may be used without limiting the scope of the present disclosure.

Embodiments of the present disclosure may provide at least one of the following advantages. As noted, using millimeter wave signals for imaging has an important advantage in that they can penetrate through poor environmental conditions such as fog, dust, and smoke that severely degrade optical-based imaging systems. However, millimeter wave radars, contrary to cameras and LiDARs, suffer from low angular resolution because of small physical apertures and conventional signal processing techniques. Existing approaches use space multiplexing (e.g., synthetic aperture radar SAR), time multiplexing (e.g., MIMO), and deep learning to improve imaging quality. However, space multiplexing requires long acquisition times and is bulky. Time multiplexing techniques are more challenging to calibrate, have increased power consumption, and large read out bandwidths. Deep learning methods have limited generalizability and, furthermore, limited access to large training data sets. The proposed application can help overcome these issues. The key novelty of this disclosure lies in the design of the proposed sparse MIMO array and neural network architecture. Specifically, the method described herein uses implicit neural representations (INR) to increase millimeter wave radar imaging accuracy. Further, the proposed system demonstrates improved imaging performance over standard millimeter wave radars and other competitive untrained methods on both simulated and experimental millimeter wave radar data. Consequently, as previously stated, the methods and systems disclosed herein can be deployed onto existing millimeter wave radars used in depth imaging applications such as in commercial automobiles and surveillance systems. This opens an abundance of useful applications such as, for example, autonomous driving, robot navigation, security monitoring, and non-destructive testing. Potential future applications include integrating the proposed system with millimeter wave communication systems (e.g., 5G NR) to allow for user tracking/localization and smart communication scheduling. One with ordinary skill in the art will appreciate that many more examples exist and may be used without limiting the scope of the present disclosure.

Embodiments disclosed herein generally relate to a method. The method includes obtaining one or more time-domain beat signals, where the one or more time-domain beat signals are obtained from an antenna array that includes a sparse multiple-input multiple-output (MIMO) linear array. The method further includes generating an under-sampled measured radar data cube based on the one or more time-domain beat signals. The method further includes determining, using a computer processor and a machine learning model, an initial scene reflectivity distribution image based on the under-sampled measured radar data cube. The method further includes synthesizing, using the computer processor, the initial scene reflectivity distribution image to obtain a synthetized full radar data cube. The method further includes processing, using the computer processor, the synthetized full radar data cube to obtain an under-sampled radar data cube. The method further includes determining, using the computer processor and the machine learning model, an enhanced scene reflectivity distribution image based on a loss function measuring a mismatch of the under-sampled radar data cube and the under-sampled measured radar data cube.

Embodiments disclosed herein generally relate to a system. The system includes a millimeter wave imaging sensor with optical access to a scene, where the millimeter wave imaging sensor includes an antenna array. The system further includes a machine learning model, where the machine learning model receives an under-sampled measured radar data cube and outputs an enhanced scene reflectivity distribution image. The system further includes a computer communicably connected to the millimeter wave imaging sensor. The computer includes a processor and a memory storing instructions. The instructions, when executed by the processor, cause the processor to obtain one or more time-domain beat signals, where the one or more time-domain beat signals are obtained from the antenna array, and where the antenna array includes a sparse multiple-input multiple-output (MIMO) linear array. The instructions, when executed by the processor, further cause the processor to generate the under-sampled measured radar data cube based on the one or more time-domain beat signals. The instructions, when executed by the processor, further cause the processor to determine, using the machine learning model, an initial scene reflectivity distribution image based on the under-sampled measured radar data cube. The instructions, when executed by the processor, further cause the processor to synthesize the initial scene reflectivity distribution image to obtain a synthetized full radar data cube. The instructions, when executed by the processor, further cause the processor to process the synthetized full radar data cube to obtain an under-sampled radar data cube. The instructions, when executed by the processor, further cause the processor to determine, using the machine learning model, the enhanced scene reflectivity distribution image based on a loss function measuring a mismatch of the under-sampled radar data cube and the under-sampled measured radar data cube.

Embodiments disclosed herein generally relate to a non-transitory computer readable medium storing instructions executable by a computer processor. The instructions, when executed by the processor, cause the processor to perform a method. The method includes obtaining one or more time-domain beat signals, where the one or more time-domain beat signals are obtained from an antenna array, and where the antenna array includes a sparse multiple-input multiple-output (MIMO) linear array. The method further includes generating an under-sampled measured radar data cube based on the one or more time-domain beat signals. The method further includes determining, using a machine learning model, an initial scene reflectivity distribution image based on the under-sampled measured radar data cube. The method further includes synthesizing the initial scene reflectivity distribution image to obtain a synthetized full radar data cube. The method further includes processing the synthetized full radar data cube to obtain an under-sampled radar data cube. The method further includes determining, using the machine learning model, an enhanced scene reflectivity distribution image based on a loss function measuring a mismatch of the under-sampled radar data cube and the under-sampled measured radar data cube.

FIG. 1A depicts a sparse Multiple-Input Multiple-Output (MIMO) linear array (100) in accordance with one or more embodiments. Initially, a transmitter array (102) illuminates a scene with a mmWave Frequency-Modulated Continuous-Wave (FMCW) pulse. Objects (104) in the scene reflect some of the incident mmWave energy back to a sparse MIMO linear receive array (“receive array (106)”). Each antenna in the receive array (106) measures a time domain beat signal (108) and each measurement is used to generate an under-sampled measured radar data cube (110). Specifically, each time domain beat signal (108) corresponds to a single row of the under-sampled measured radar data cube (110).

A time domain beat signal (108) is the result of mixing the transmitted signal (i.e., the FMCW pulse) with the echo received from the objects (104). When this signal reflects off objects (104) and returns to the receive array (106), it is delayed in time. Mixing the transmitted and received signals produces a new signal whose frequency equals the difference between the instantaneous frequencies of the transmitted and received signals. This difference is called the beat frequency. In a radar system with a receive array (106) (i.e., multiple antennas placed at known spatial intervals) the returned signal is received by each element of the receive array (106). Due to the geometry and the angle of arrival of the signal, each antenna element of the receive array (106) experiences a different phase and time delay. After mixing the received signal at each antenna with the transmitted signal (or, in some cases, a local reference) each element of the receive array (106) outputs a beat signal.

FIG. 1B depicts a millimeter wave imaging sensor (112). The millimeter wave imaging sensor (112) consists of 16 receive antennas, 12 transmit antennas, and 4 radar chips. The millimeter wave imaging sensor (112) operates at 77 Gigahertz (GHz) and has a 862/2 uniform linear array with an azimuth angular resolution of 1.33° and an elevation angular resolution of 22.5°. During data collection, the millimeter wave imaging sensor (112) transmits a 1.282 GHz bandwidth FMCW pulse, resulting in a 0.117 m depth resolution. In addition, during data acquisition the millimeter wave imaging sensor (112) is mounted on a handheld rig and moved throughout several diverse indoor and outdoor environments.

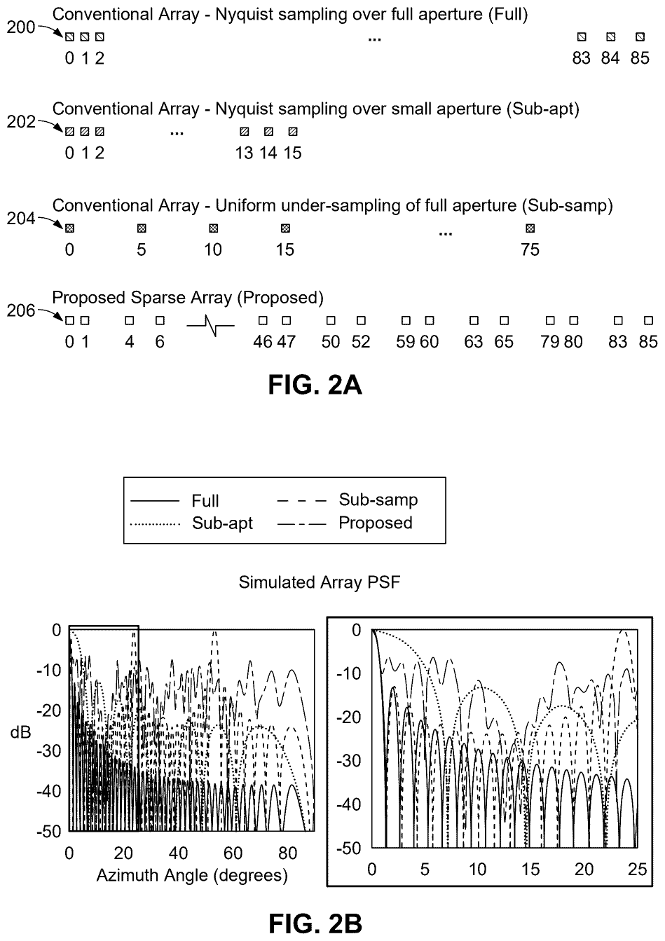

In accordance with one or more embodiments, FIGS. 2A and 2B depict a comparison of different MIMO virtual array (100) designs.

The quality of a sparse virtual array design can be determined by analyzing its point spread function (PSF). Specifically, the PSF's main lobe Half Power Beam Width (HPBW), maximum Side Lobe Level (SLL), and grating lobes provide an indication of the achievable angular resolution and imaging ambiguities, respectively. The sparse MIMO virtual array's PSF in the far field is computed by multiplying the PSFs of the physical transmitter and receiver MIMO arrays.

The design of the sparse virtual array must satisfy hardware constraints that limit the max aperture to 86λ/2, with λ being equal to 3.9 millimeters (mm). Additionally, a majority of commercial single chip radar can only support four transmitters and four receivers. Accordingly, in the design of the proposed sparse array, the virtual array's PSF is analyzed, and a design is chosen such that: (i) the design does not contain grating lobes within a ±90° field-of-view (FoV), (ii) the design minimizes the HPBW, (iii) the design minimizes the SLL, and (iv) the design meets hardware constraints.

The design methodology for the sparse array disclosed herein is divided into two steps. First, a four-element receive array is chosen to meet constraint (i). Specifically, a four element minimum redundant array (MRA) with receivers located at [0, 1, 4, 6](λ/2) is used. This array design replicates the spatial frequency coverage of a seven element uniform array without introducing grating lobes within the FoV.

After establishing the receiver array design, the second step of the design process focuses on the four-element transmitter array. To minimize the HPBW, as required to meet constraint (ii), two transmitters are placed at [0, 79]λ/2, which maximizes the virtual array aperture while still meeting the hardware aperture constraints (iv). To determine the best position of the remaining two transmitters, a brute-force grid search is implemented within the set E∈{0, . . . , 79}λ/2 that minimizes the SLL of the virtual array's PSF (iii). For each of the ≈3×103 transmitter array designs evaluated in the gird search, the transmitter array PSF is multiplied by the fixed receiver array PSF to generate the corresponding virtual array PSF. After the grid search is complete, the transmitter array design that minimizes the SLL in the virtual array PSF is chosen.

Specifically, FIG. 2A shows the sparse virtual array design disclosed herein (“Proposed (206)”) and three arrays constructed using conventional MIMO array design techniques (“Full (200),” “Sub-apt (202),” and “Sub-samp (204),” respectively). The ideal, full-aperture Nyquist-sampled array labeled as Full (200) can be constructed by neglecting the single-chip hardware constraint (iv). The Sub-apt array (202) is the largest Nyquist sampled MIMO array that can be synthesized from four transmitters and four receivers. In the Sub-apt array (202), the receivers and transmitters are positioned at [0, 1, 2, 3]λ/2 and [0, 4, 8, 12]λ/2, respectively. The Sub-samp array (204) is a subsampled array designed to maximize the aperture size using four transmitters and four receivers, while staying within the maximum aperture limit 862/2. In the Sub-samp array (204), the receivers and transmitters are positioned at [0, 5, 10, 15]λ/2 and [0, 20, 40, 60]λ/2, respectively. The Proposed array (206) is obtained following the design methodology describe above and the transmitters are positioned at [0, 46, 59, 79]λ/2, which yields the best results with respect to constraints (i)-(iv).

FIG. 2B shows the simulated array PSF for each one of the MIMO virtual array (100) designs. The plots in FIG. 2B have been normalized to λ/2 increments. FIG. 2B demonstrates that the Full array (200) provides an ideal PSF response with a narrow HPBW, low SLL, and no grating lobes. In addition, FIG. 2B shows that, due to the small aperture in Sub-apt array (202), the HPBW is 5.2× larger than in the Full array (200). Further, FIG. 2B shows that in the Sub-samp array (204) there are four grating lobes within the FoV due to the sub-Nyquist sampling of the array. As also shown in FIG. 2B, the Proposed (206) sparse array's simulated PSF has a reduced SLL of −6 dB, removes grating lobes in the FoV, and has a ≈1.3° HPBW, which is comparable to the Full (200) dense virtual array.

Generally, a MIMO radar data cube measurement (z) can be obtained given a scene reflectivity distribution (x̅) as follows:

$$z = ℱ ( \overline{x} ) + w \qquad Equation ( 1 )$$

In EQ. 1, [symbol] (·) implements the two-dimensional (2D) Fast Fourier Transform (FFT). EQ. 1 is referred to as “forward model” in the present disclosure. The scene reflectivity distribution image is a complex-valued polar image of the scene's reflectivity distribution. In practice, typically the magnitude of the scene reflectivity distribution image (i.e., |x̅|) is used to visualize the reflectivity distribution.

The proposed methods and systems of this disclosure recover an image of a scene's complex reflectivity distribution (\hat{x}) from a single, under-sampled measured radar data cube (z). The radar data cube z can be obtained mathematically as:

$$z = M ⊙ ℱ ( \hat{x} ) + w \qquad Equation ( 2 )$$

In EQ. 2, └ is the Hadamard product, M is a binary mask that implements under-sampling, and w is complex white Gaussian noise with zero mean and variance. The Hadamard product is an element-wise multiplication between two matrices of the same dimensions. That is, given two matrices A and B, their Hadamard product is a new matrix of the same shape where each element is the product of the corresponding elements in A and B. The measurements in z, the radar data cube, are FMCW beat signal samples captured at each antenna in the receive array (106). If a full uniform linear array with antenna spacing λ/2 is used, the mask M would be a matrix of ones, and the radar measurements would be acquired according to EQ. 1. In that case, the image can be estimated up to the uncertainty of the additive noise as \hat{x}= [symbol] ⁻¹(z), where [symbol] ⁻¹(·) is the inverse 2D FFT.

Sparse radar imaging can be employed to reduce the number of antennas needed for imaging, leading to decreased power consumption and read-out bandwidth. As previously described, embodiments of the present disclosure focus on sparse radar imaging, where the number of antennas is under-sampled, resulting in a sparse linear array. This can be modeled by multiplying the radar data cube z by a binary mask M, which sets a subset of rows in z to zero. The problem then amounts to recovering an image of the scene reflectivity distribution from an under-sampled set of measurements, which can be classified as a compressed sensing problem. In this compressed sensing regime, using [symbol] ⁻¹(·) to estimate the image \hat{x} will result in aliasing artifacts from the large sidelobes in the sparse array's point spread function (PSF), making it difficult to discriminate reflectors in the image.

Embodiments of the present disclosure optimize the weights of an untrained deep convolutional neural network to invert EQ. 2. Consider an untrained network G(·;p) which takes a fixed C as input and is parameterized by weights p. In the present disclosure, the weights of the deep network are optimized such that the forward model (EQ. 1) applied to the network output matches the given radar measurements z. In addition, in the present disclosure, G(·; p) is initialized with a fixed C drawn from a uniform distribution of independent and identically distributed entries, and used to solve an optimization problem of the form:

$$\hat{p} = arg {min}_{p} {‖ z - M ⊙ ℱ ( G ( C ; p ) ) ‖}_{2} \qquad Equation ( 3 )$$

In addition, embodiments of the present disclosure additionally leverage sparsity in the image domain by applying the L1-norm on the network output. This helps enforce the prior that mmWave images are sparse in the spatial domain due to the dominant specular reflections from objects at this wavelength. Thus, the final optimization process becomes:

$$\hat{p} = arg {min}_{p} {‖ z - M ⊙ ℱ ( G ( C ; p ) ) ‖}_{2} + {λ}_{L} {‖ G ( C ; p ) ‖}_{1} \qquad Equation ( 4 )$$

In EQ. 4, λ_{L} is the L1-norm hyperparameter. The estimated image of the scene is given as \hat{x}=G (C; p). Embodiments disclosed herein optimize over x̅ in the range of a deep network conditioned on the L1-norm ball. In traditional compressed sensing, the optimization is only constrained on the L1-norm ball. In contrast, in the method and systems disclosed herein, the deep network's convolutional structure has an implicit biased towards smooth, natural images while maintaining a high impedance to noise. In one or more embodiments, over-parameterizing the deep network by a factor of 13 and adding the L1-norm prior helps find a solution that balances fitting the salient features in the scene, while suppressing noise and aliasing artifacts.

As previously stated, using the inverse FFT to estimate the image will result in aliasing artifacts from the large sidelobes in the sparse array's PSF that make it difficult to discriminate reflectors in the image. Accordingly, the proposed methods and systems of this disclosure design and make use of a sparse MIMO virtual array that, when used in conjunction with the machine learning (ML) model (300) described herein, improves radar imaging accuracy.

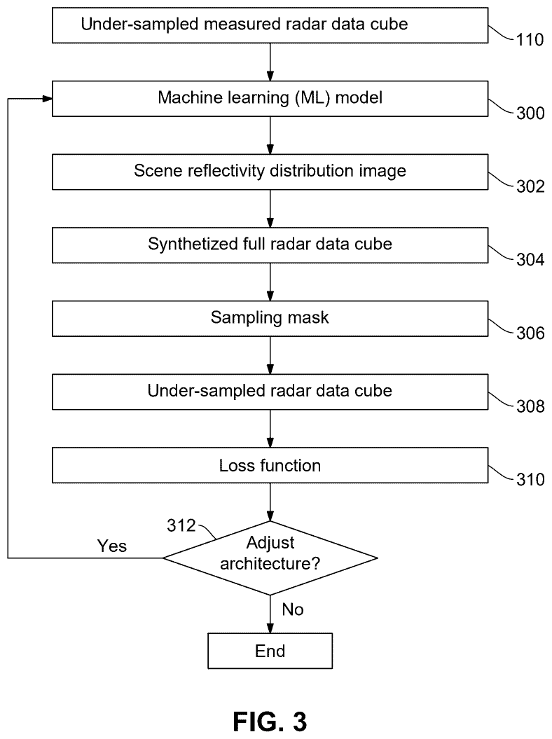

FIG. 3 depicts a flowchart which describes in greater detail the process of developing and using the ML model (300) to reconstruct a scene reflectivity distribution image from an under-sampled radar measurement, in accordance with one or more embodiments. Initially, an under-sampled measured radar data cube (110) is obtained. As previously described, when a transmitter array (102) illuminates a scene with a FMCW pulse, objects (104) in the scene reflect some of the incident mmWave energy back, and each antenna in the receive array (106) measures a time domain beat signal (108). Each measurement is then used to generate an under-sampled measured radar data cube (110). Specifically, each time domain beat signal (108) corresponds to a single row of the under-sampled measured radar data cube (110).

In accordance with one or more embodiments, the under-sampled measured radar data cube (110) is inputted into the ML model (300) and the ML model (300) outputs a scene reflectivity distribution image (302). The scene reflectivity distribution image (302) is a complex-valued polar image of the scene's reflectivity distribution. In practice, typically the magnitude of the scene reflectivity distribution image (302) is used to visualize the reflectivity distribution.

Machine learning, broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), will be adopted herein, however, one skilled in the art will recognize that the concepts and methods detailed hereafter are not limited by this choice of nomenclature.

ML model types may include, but are not limited to, generalized linear models, Bayesian regression, random forests, and deep models such as neural networks, CNNs, and recurrent neural networks. ML model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Hyperparameters governing a CNN decoder may include an L1 norm. Commonly, in the literature, the selection of hyperparameters surrounding a ML model is referred to as selecting the model “architecture.” Once a ML model type and hyperparameters have been selected, the ML model is used to perform a task. In accordance with one or more embodiments, a CNN decoder (300) and selected hyperparameters (e.g., L1 norm) are used to capture the underlying salient features in the reflectivity distributions. That is, the under-sampled measured radar data cube (110) is inputted into the ML model (300) and the ML model (300) outputs a scene reflectivity distribution image (302).

Herein, a cursory introduction to various ML models such as a neural network (NN) and a convolutional neural network (CNN) are provided, as these models are often used as components (or may be adapted and/or built upon) to form more complex models. However, it is noted that many variations of NNs, CCNs, and decoders exist. Therefore, one with ordinary skill in the art will recognize that any variations to the ML model (300) that differs from the introductory models discussed herein may be employed without departing from the scope of this disclosure. Further, it is emphasized that the following discussions of ML models are basic summaries and should not be considered limiting.

In accordance with one or more embodiments, the ML model (300) discussed herein is a CNN decoder. Neural networks are described in greater detail below. A CNN is similar to a neural network in that it can technically be graphically represented by a series of edges and nodes grouped to form layers. However, it is more informative to view a CNN as “structural” groupings of weights, where here the term structural indicates that the weights within a group have a relationship. CNNs are widely applied when the data inputs also have a structural relationship, for example, a spatial relationship where one input is always considered “to the left” of another input. Images, which may be three-dimensional, have such a structural relationship because each data element, or pixel, in the data has a spatial location. Consequently, a CNN is an intuitive choice for processing. Unlike fully connected networks that treat every pixel as independent and require a separate weight for each connection, CNNs share weights across different regions. This not only significantly reduces the number of parameters but also makes the model more efficient and scalable for high-dimensional image data.

A structural grouping, or group, of weights is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto a neural network, the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, where no more filters act on these intermediate representations. In some instances, the structural relationship of the final intermediate representations is ablated; a process known as “flattening.” The flattened representation may be passed to a neural network to produce a final output. In this context, the neural network is still considered part of the CNN. After initialization of the filter weights, the edge values of the neural network are updated with the backpropagation process in accordance with a loss function. Backpropagation is described in greater detail below.

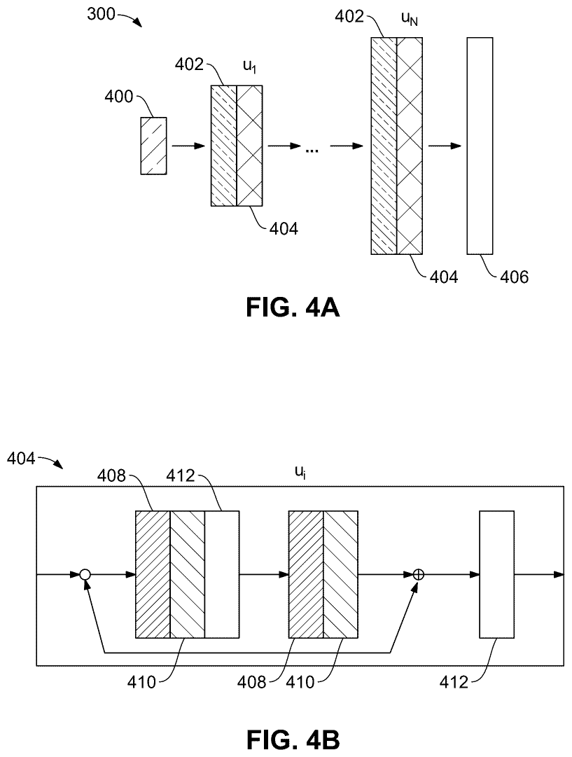

A diagram of a CNN decoder (300) architecture is shown in FIG. 4A. As shown, the CNN decoder (300) architecture includes an input (400), an upsampling layer (402), a residual block (404), and a final layer (406). In accordance with one or more embodiments, the input (400) to the CNN decoder (300) is an under-sampled measured radar data cube (110). Each layer except the last layer is composed of an upsampling layer (402) followed by a residual block (404). The upsampling layer (402) operation induces a fixed notion of resolution in each layer.

The residual block (404) is shown in more detail in FIG. 4B and includes a convolutional layer (408), a batch normalization layer (410), and an activation function (412). After each upsampling layer (402), which increases spatial dimensions, a convolutional layer (408) is applied to process the expanded feature maps. In accordance with one or more embodiments, when fitting the network to a given under-sampled measurement, only the parameters in the convolutional layer (408) and batch normalization layer (410) are optimized.

The residual block (404) structure helps propagate information captured at lower layers up to higher layers by structurally adding an identity mapping in each layer. The convolutional layer (408) shapes the upsampled outputs into high-resolution representations and captures local information among nearby pixels at varying resolutions per layer. This helps the ML model (300) learn how to combine the upsampled data with features learned earlier in the network, and often incorporating information from “skip” connections. In addition, the convolutional layer (408) helps restore fine spatial details and suppress noise.

Keeping with FIG. 4B, in accordance with one or more embodiments, the activation function (412) comprises a Sigmoid Linear Unit (SiLU) activation function. Using the SiLU activation function (412) instead of the traditional Rectified Linear Unit (ReLU) activation function results in improved reconstructions. This is because the SiLU function is non-monotonic and helps the ML model (300) be more expressive. The final layer (406) excludes upsampling and linearly combines the hidden channels to the output channels c using a 1×1 convolutional layer. In all cases, since the image of the reflectivity distribution is complex, c=2 for the real and imaginary part of the scene reflectivity distribution image (302).

In accordance with one or more embodiments, the ML model (300) architecture described herein consists of 6 layers (including the last layer) with 128 channels per layer, and a fixed input drawn from a uniform distribution. The network weights are updated by optimizing EQ. 4 and backpropagating the loss, as described below. Optimizing EQ. 4 for 2000 iterations on a single 256×256 radar reflectivity image takes under 50 seconds using the methods and systems disclosed herein.

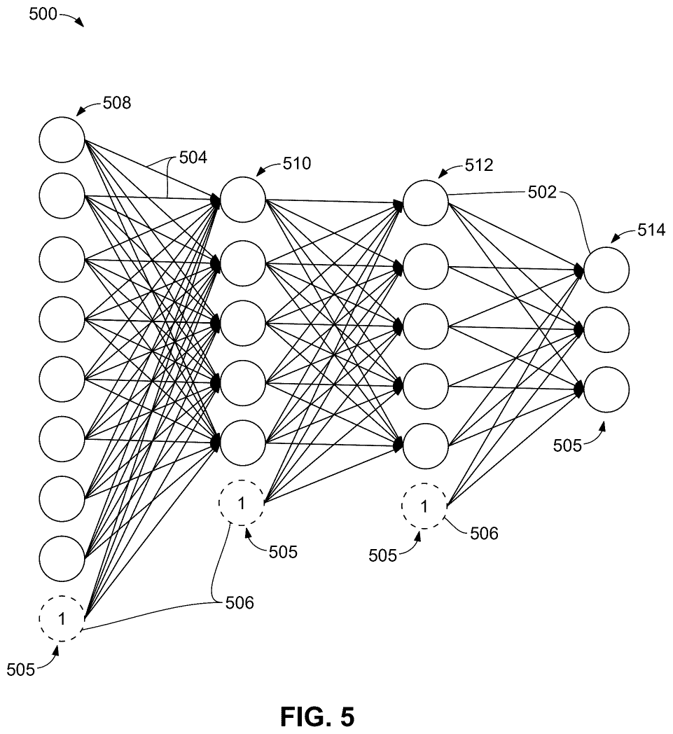

A CNN may be more readily understood as a specialized neural network. Thus, a cursory introduction to a neural network is provided below. A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer.” Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters.” Numerical values are assigned to each edge (504). Additionally, every node (502) is associated with a numerical variable and an activation function. Activation functions are not limited to any functional class, but traditionally follow the form

$$A = f ) {\sum }_{i ∈ ( incoming )} [ {( node value )}_{i} {( edge value )}_{i} ] ) \qquad Equation ( 5 )$$

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is being computed. Some functions for ƒ may include the linear function ƒ(x)=x, sigmoid (SiLU) function

$$f ( x ) = \frac{1}{1 + {e}^{- x}} ,$$

and rectified linear unit (ReLU) function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle. Alternately, in some neural networks, the bias term is node-dependent and set as a learnable parameter and may not be a fixed separate node in the neural network.

In some implementations, the neural network (500) may contain specialized layers (505), such as a normalization layer, or additional connection procedures, like concatenation. One skilled in the art will appreciate that these alterations do not exceed the scope of this disclosure.

As noted, the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Recall, that a given data set will be composed of inputs and associated target(s), where the target(s) represent the “ground truth,” or the otherwise desired output.

In accordance with one or more embodiments, several untrained methods to perform sparse radar imaging are implemented and compared against the method and systems disclosed herein. For all methods, the architecture designs and regularization parameters for the network and gradient descent methods are identified such that they maximize the simulated and experimental reconstruction quality. In one or more embodiments, the reconstruction quality for the methods and systems disclosed herein is maximized when a L1-norm hyperparameter of 1e-5 is used. The same L1-norm hyperparameter is applied to all network methods to make a fair comparison. All iterative methods are run for 2000 iterations (i.e., until convergence is reached) and retain the images that correspond to the lowest loss during the optimization. Each untrained method used for comparison is described next.

The delay-and-sum (“DAS”) or conventional beamformer method implements the inverse 2D FFT of the under-sampled measured radar data cube (110) (z) to estimate the scene reflectivity distribution image (302) (x) up to the uncertainty of the additive noise. Mathematically:

$${\hat{x}}_{DAS} = {ℱ}^{- 1} ( z ) \qquad Equation ( 6 )$$

This DAS method is referred to as “Sparse DAS” herein when the measured radar data cube is sub-sampled. In accordance with one or more embodiments, for experimental data where there is no access to the ground truth scene reflectivity, the scene reflectivity distribution image (302) can be approximated using EQ. 6 with a fully sampled data cube z. This method is referred to as “Full DAS” herein.

The methods and systems disclosed herein leverage the implicit bias of the structure of a convolutional decoder by optimizing the weights of the network rather than the scene reflectivity distribution. To test the reconstruction performance without inductive bias, a gradient descent (“GD”) method with L1-norm regularization (“L1 Reg.”) is implemented to optimize the scene reflectivity distribution directly. Mathematically:

$$\hat{x} = arg {min}_{\overline{x}} {‖ z - M ⊙ ℱ ( \overline{X} ) ‖}_{2} + {λ}_{L} {‖ \overline{X} ‖}_{1} \qquad Equation ( 7 )$$

In EQ. 7, λ_{L} is the L1-norm regularization hyperparameter. The reflectivity distribution x̅ is initialized with samples from a uniform distribution. In EQ. 7 the optimization is biased towards sparse spatial domain solutions due to the L1-norm handcrafted prior. In one or more embodiments, the reconstruction quality is maximized when λ_{L} is 1e-3 for simulated and 1e-2 and experimental data, respectively. This method is referred to as “GD+L1 Reg.” herein.

Another untrained method uses INRs that consist of multi-layer perception (MLP) layers that map an extremely low-level input to a low-level output. For example, inputs could be coordinates in a scene (x, y) and the output could be a physical property of that scene such as its mmWave reflectivity. These networks learn an implicit continuous representation of the input and output mapping. To implement the INR method with EQ. 4, the network G architecture is updated, and the input C is changed to represent all the range and angle coordinates in a K by L image normalized between [−1, 1].

A first INR method uses ReLU activation functions with Fourier feature encoding. This method is referred to as “INR-ReLU” herein. Setting Q=256, κ=20, the number of layers to 7, and the number of neurons per layer to 256 resulted in the best reconstruction quality for this method. A second INR method uses sinusoidal periodic activation functions. This INR architecture does not require an explicit feature encoding operation but instead adjusts the initial frequency ω₀ of the network's first layer to scale its ability to learn high frequency information. This method is referred to as “SIREN” herein. Setting ω₀=30, the number of layers to 7, and the number of neurons per layer to 256 resulted in the best reconstruction quality for this method.

Another untrained neural network architecture method uses a U-net convolutional neural architecture containing an encoder, decoder, and skip connections. This approach takes a high-dimensional input with samples drawn from a uniform distribution and outputs a high-dimensional estimate, i.e., image of the scene's reflectivity distribution. This method is referred to as “DIP” herein. To implement the DIP method with EQ. 4, the network G architecture is updated, and the input C is increased to match the desired output K by L image dimensions. Using 128 channels per layer, 6 encoder and decoder layers, a SiLU activation function, and nearest neighbor upsampling resulted in the best reconstruction performance for the DIP method.

The next untrained neural network method uses a decoder architecture containing channel-wise convolution, bilinear upsampling, ReLU activation, and batch normalization operations per layer. This method takes in a low-dimensional input and outputs a high-dimensional estimate. Only the upsampling operation applies spatial pixel coupling in this architecture. This method is referred to as “DeepDecoder” herein. To implement this method with EQ. 4, the network G architecture is updated, and the input C matches the methods and system disclosed herein with an increased number of channels. Using 6 layers with 512 channels per layer results in the best reconstruction performance for this method.

The final untrained neural network method is a variant of DeepDecoder, with the major changes including 3×3 convolutions and nearest-neighbor upsampling per layer. This method takes in a low-dimensional input and outputs a high-dimensional estimate. This method is referred to as “ConvDecoder” herein. To implement this method with EQ. 4, the network G architecture is updated, and the input is generated following the same procedure as used for the methods and systems disclosed herein. Using 6 layers with 128 channels per layer resulted in the best reconstruction performance for this method.

Returning to FIG. 3, using a 2D FFT, the scene reflectivity distribution image (302) is synthesized to obtain a synthetized full radar data cube (304).

As previously described, sparse radar imaging can be employed to reduce the number of antennas needed for imaging, leading to decreased power consumption and read-out bandwidth. In such case, the number of antennas is under-sampled, resulting in a sparse linear array. This under-sampled representation of the synthetized full radar data cube (304) can be obtained by multiplying the synthetized full radar data cube (304) with a sampling mask (306). The sampling mask (306) is a binary mask. A binary sampling mask is a matrix or array of ‘zero’ and ‘one’ values used to control which elements in another array (e.g., the synthetized full radar data cube (304)) are selected (sampled) or ignored (masked out). Accordingly, multiplying the synthetized full radar data cube (304) with a sampling mask (306) sets a subset of rows in the synthetized full radar data cube (304) to zero, and only the rows of the synthetized full radar data cube (304) corresponding to the sparse receive array (106) antenna locations are retained. The result is an under-sampled radar data cube (308). In accordance with one or more embodiments, the multiplication between the synthetized full radar data cube (304) with the sampling mask (306) is performed using a Hadamard product, as previously described.

Continuing with FIG. 3, the ML model output (300) (that is, the under-sampled radar data cube (308) generated from the scene reflectivity distribution image (302)) is compared to the under-sampled measured radar data cube (110). This comparison is typically performed by a so-called “loss function” (310) although other names for this comparison function such as “error function,” “misfit function,” and “cost function” are commonly employed. Many types of loss functions (310) are available, such as the mean-squared-error function. However, the general characteristic of a loss function (310) is that the loss function (310) provides a numerical evaluation of the similarity (or mismatch) between the ML model (300) output (i.e., the under-sampled radar data cube (308)) and the under-sampled measured radar data cube (110). The loss function (310) may also be constructed to impose additional constraints on the values assumed by the edges (504). For example, by adding a penalty term, which may be physics-based, or a regularization term. Generally, the goal is to alter the edge (504) values to promote similarity between the ML model (300) output (i.e., the under-sampled radar data cube (308)) and the under-sampled measured radar data cube (110). Thus, the loss function (310) is used to guide changes made to the edge (504) values, typically through a process called “backpropagation.”

Backpropagation consists of computing the gradient of the loss function over the edge (504) values. The gradient indicates the direction of change in the edge (504) values that results in the greatest change to the loss function (310). Because the gradient is local to the current edge (504) values, the edge (504) values are typically updated by a “step” in the direction indicated by the gradient. The step size is often referred to as the “learning rate” and need not remain fixed. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the ML model (300) will likely produce different outputs. Thus, the procedure of propagating at least one input through the neural network (500), comparing the neural network (500) output with the associated target(s) with a loss function (310), computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change (i.e., mismatch) in the loss function (310) between iterations; reaching a specified performance metric as evaluated on the data or a separate hold-out data set.

In accordance with one or more embodiments, the termination criteria is an iteration counter set to 2000 iterations. Setting the iteration counter to 2000 iterations provides sufficient optimization updates for all methods to reach a level of convergence where the loss standard deviation is below 1e-2 over the past 20 loss updates. In one or more embodiments, the convergence criterion used to determine if convergence has been reached is given by:

$$Var ( x ) = \frac{1}{n} {\sum }_{k = i - n}^{n} {( {x}_{k} - \frac{1}{n} {\sum }_{k = i - n}^{n} {x}_{k} )}^{2} \leq ϵ \qquad Equation ( 8 )$$

In EQ. 8, xₖ is the optimization loss at iteration i, n is the window size used to compute the convergence statistic, and ϵ is the convergence criterion. In one or more embodiments, the window size is set to 20 and the convergence criterion is set to 1e-2.

In accordance with one or more embodiments, mismatch between the measured radar data cube (110) and the radar data cube (308) generated using the neural network refers to the difference between the two data cubes in the complex domain. Specifically, the mismatch is measured as the L2-norm difference between the real and imaginary components of the generated radar data cube (308) and the measured radar data cube (110).

Keeping with FIG. 3, a determination (312) is made as to whether the ML model (300) architecture needs to be altered. If the ML model (300) performance, as measured by a comparison function, is suitable, then the ML model (300) is accepted for use. A commonly used comparison function is the mean-squared-error function, which quantifies the difference between the predicted value and the actual value when the predicted value is continuous. However, one with ordinary skill in the art will appreciate that many more comparison functions exist and may be used without limiting the scope of the present disclosure. For example, a comparison can be performed using the cross-entropy function.

If the ML model performance is not suitable, the ML model architecture may be altered (i.e., return to the ML model (300)) and the process is repeated. There are many ways to alter the ML model architecture in search of suitable ML model (300) performance. These include, but are not limited to, selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the process is complete (“End”).

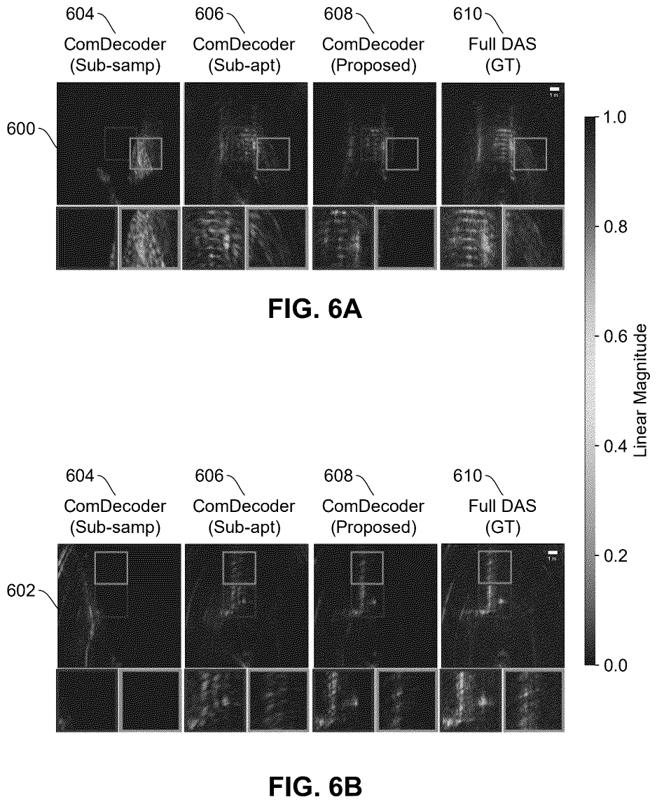

FIGS. 6A and 6B show reconstructions for two outdoor scenes (600, 602) using the ML model (300) with the three different sparse MIMO apertures developed in FIG. 2A, in accordance with one or more embodiments. FIG. 6A depicts experimental results for a first scene (600) with a Sub-samp (204, 604), Sub-apt (202, 606), and Proposed (206, 608) spare MIMO array design, respectively. The last column (610) in FIGS. 6A and 6B depicts the ground truth (GT) obtained using the Full DAS reconstruction. FIG. 6B depicts experimental results for a second scene (602) with the same spare MIMO array designs as those shown in FIG. 6A.

FIGS. 6A and 6B show that the Sub-samp design (604) leads to incorrect positioning of reflectors in the scene due to grating lobes in the aperture's PSF. The Sub-apt design (606) captures the salient features in the scene but with an increased blurring compared to the Full DAS reconstruction. The proposed sparse array design (608) achieves the best reconstruction when compared to Full DAS. These results suggest that designing sparse arrays with no grating lobes and a narrow main lobe leads to the best reconstruction results when combined with the CNN decoder (300) architecture shown in FIGS. 4A and 4B.

As previously described, the ideal reconstruction method should remove spurious artifacts caused by the high side lobes in the sparse array's PSF and recover a radar image of the scene's reflectivity distribution that is perceptually similar to the radar image formed using a dense full array (i.e., Full DAS). However, since the experimental radar data is noisy and is collected using a finite array, the Full DAS reconstruction contains aliasing artifacts that appear as a radially smearing of energy in the radar image.

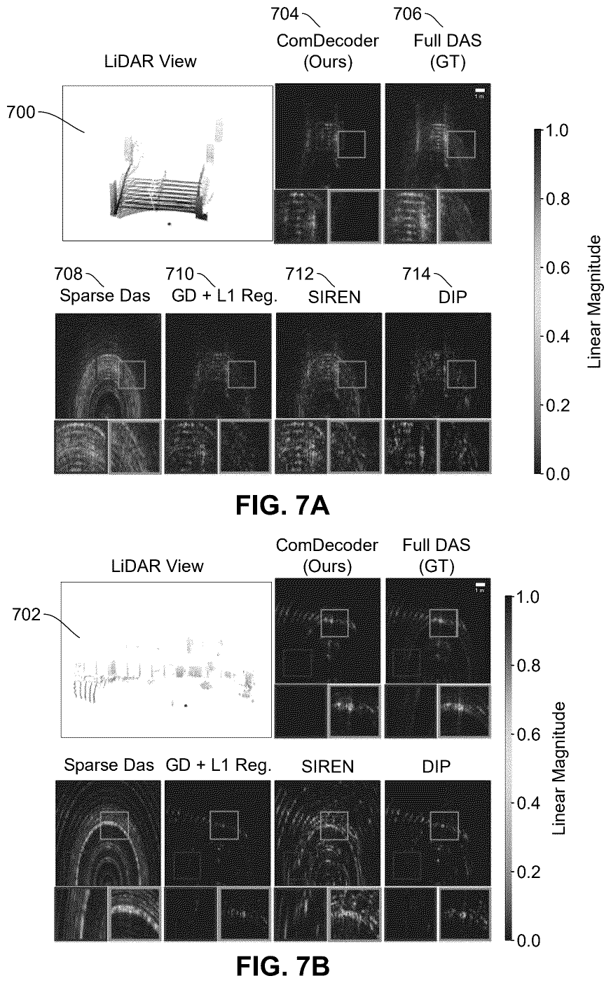

FIGS. 7A and 7B shows sparse radar imaging reconstructions using the methods and systems disclosed herein (704) and competing methods (708, 710, 712, 714) for two different scenes, in accordance with one or more embodiments. All the methods are run for 2000 iterations until convergence, and the learning rate is set to 1e-3 for all iterative methods, except for SIREN which uses a learning rate of 1e-4 to stabilize the optimization. Each method's hyperparameters are set to the values previously discussed. In FIGS. 7A and 7B, a LiDAR view is shown only for illustrative purposes and is not used in the reconstruction process. The dots in FIGS. 7A and 7B show the location of the millimeter wave imaging sensor (112). Since the true reflectivity distribution of the experimental data is unknown, Full DAS (706) reconstruction is used as the GT and compared to the other sparse radar imaging methods. All methods are evaluated using outdoor data collected in a courtyard scene and indoor data collected within office spaces, as described in greater detail below.

FIG. 7A shows the reconstruction results for an outdoor scene (700) where the dominate feature is a staircase. As shown, the methods and systems disclosed herein (704), SIREN (712), and DIP (714) are the only methods to clearly recover the periodic reflections arising from the stair steps in the staircase. Additionally, the methods and systems disclosed herein (704) significantly outperform DIP (714) and all other methods (708, 710, 712, 714) at removing aliasing artifacts arising from side lobes in the array's PSF. DIP (714) struggles at achieving the same level of aliasing artifact suppression as the methods and systems disclosed herein (704) because of its increased number of parameters. This is because without additional regularization, such as early stopping, DIP (714) has the capacity to fit both an underlying signal and noise in a measurement.

Next, each method is tested on mmWave data captured in an indoor environment scene (702). The indoor scene (702) reconstruction results are shown in FIG. 7B. The dominant features in this scene are 14 poles aligned in a row. All methods (704, 710, 712, 714) appear to have improved performance over the Sparse DAS (708) reconstruction and are able to localize the reflections from the poles. In the indoor scene, the methods and systems disclosed herein (704) and DIP (714) more accurately reconstruct the salient features present in the Full DAS (706) reconstruction, with the methods and systems disclosed herein (704) having superior aliasing artifact suppression. In addition, a significant degradation in SIREN (712) reconstruction quality is observed, which could be caused by an increased level of noise in the measurements from multipath effects. Since SIREN (712) does not use convolutional layers, there is not an explicit spatial local filtering bias being applied by the network that can help suppress noise.

FIGS. 7A and 7B demonstrate that, in both environments, the methods and systems disclosed herein (704) more accurately reconstruct the periodic features in each scene, such as the stair steps and guard rails (FIG. 7A) and indoor wall (FIG. 7B), while removing aliasing artifacts.

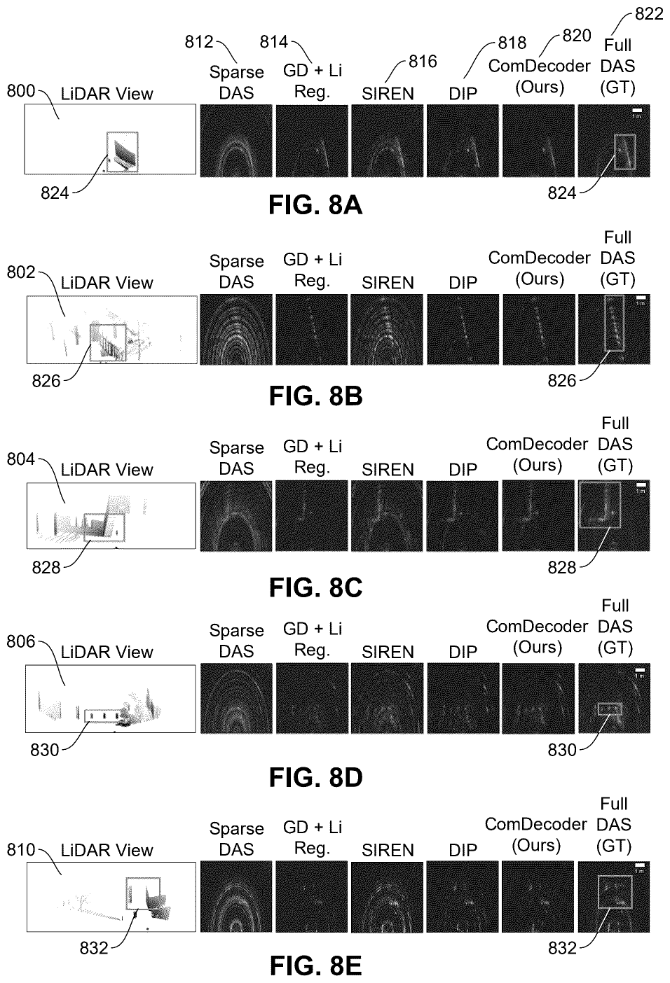

FIGS. 8A-8E show reconstruction performance of the methods and systems disclosed herein (820) and competing methods (812, 814, 816, 818) on several outdoor scenes (800, 802, 804, 806, 810) with varying complexity, in accordance with one or more embodiments. A LiDAR view provides a perceptual view of each scene (800, 802, 804, 806, 810). The reconstructed image from the conventional full array, i.e., Full DAS (822), is used as a benchmark to compare against the methods and systems disclosed herein (820) and the other competing methods (812, 814, 816, 818). The boxed regions (824, 826, 828, 830, 832) highlight the corresponding features that are captured in both the LiDAR and mm Wave images.

All methods (814, 816, 818, 820) show improved performance over the Sparse DAS (812) reconstruction, but lack the performance of convolutional network methods. Gradient descent with an L1-norm prior (814) is able to estimate the dominate reflectors in the scene but is not able to completely suppress all aliasing artifacts. SIREN (816) fits to both the strong reflectors in the scene and aliasing artifacts. This could be because, contrary to natural images, radar images characteristically have small, localized regions of high energy and a sparse distribution of weaker reflectors throughout the image. This arises from the mmWave's reflections being predominately specular instead of diffuse. Thus, even though SIREN (816) and other MLP based architectures have an implicit biased towards natural images, they struggle at differentiating reflectors from structured aliasing artifacts in the radar images. CNN architectures (820) have an inductive bias applied by the convolution operations, upsampling method, and skip connections. The convolution operations induce a notion of spatial locality between pixels, while upsampling applies a notion of resolution per layer. The structure of the skip connections influences the flow of information between layers and can smooth out the optimization. Taken together, these inductive biases improve the sparse radar imaging performance. Compared to DIP (818), the methods and systems disclosed herein (820) are closer to the conventional full array reconstructions, i.e., Full DAS (822), with increased noise suppression. This could be attributed to the methods and systems disclosed herein (820) having fewer parameters compared to DIP (818) and using a ResNet decoder architecture instead of a U-net.

The Sparse DAS (812) reconstructions shown in FIGS. 8A-8E are significantly corrupted by aliasing artifacts from the sparse radar aperture, causing the true angular location of objects (104), such as the wall corner (828) in the scene (804) of FIG. 8C, to be indistinguishable from the background aliasing.

The GD+L1 Reg. (814) reconstruction method estimates the dominant reflectors in the scene but does not suppress all aliasing artifacts or reconstruct the weak reflections from extended targets. For example, the GD+L1 Reg. (814) reconstruction method does not accurately capture the ground reflections in front of the wall (824) in scene (800), as shown in FIG. 8A.

The SIREN (816) reconstruction method fits both the strong reflectors in the scene and the aliasing artifacts. This could be attributed to MLP-based methods, e.g. SIREN (816), not having explicit architectural components such as convolutional layers (408) that provide a notion of spatial locality. The result is that SIREN (816) is unable to significantly separate the underlying scene from the structured aliasing artifacts. This effect is demonstrated in SIREN's (816) inability to reconstruct the reflections from the pillars (826) in scene (802), as shown in FIG. 8B.

The DIP (818) reconstruction method has an increased level of background noise. This can be observed in scene (800) of FIG. 8A and scene (804) of FIG. 8C as speckle noise outside of the regions denoted with the box (824, 828). The improved noise suppression in the methods and systems disclosed herein (820), compared to DIP (818), could be attributed to neural network architectural differences and neural network parameter reduction.

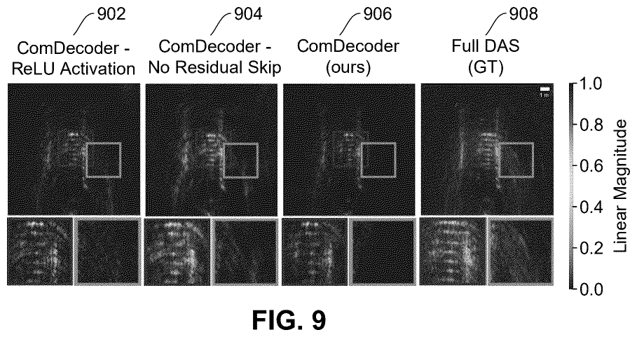

FIG. 9 shows reconstructions for a single experimental scene across several variants in accordance with one or more embodiments. As previously described, the methods and systems disclosed herein (906) have several distinct neural network architectural changes compared to traditional methods. These include altering each layer in the CNN generator to use a ResNet-like structure and changing the activation function from ReLU to SiLU. In the ReLU activation variant (902), the network architecture described in FIGS. 4A and 4B is used, but the nonlinearities are switched to ReLU activation functions. For the “No residual skip” variant (904), the network architecture described in FIGS. 4A and 4B is used, but without skip connections between convolutional layers. The last column (908) in FIG. 9 depicts the GT obtained using the Full DAS reconstruction.

As shown in FIG. 9, while the ReLU activation variant (902) is able to reconstruct a majority of the salient features in the scene, it results in an increased amount of aliasing artifacts in the final reconstruction image. Using the “No residual skip” variant (904) without residual skip connections results in some of the more complex features in the scene not being reconstructed completely (e.g., stair steps are not as defined because of the decreased contrast). In contrast, the methods and systems disclosed herein (906) shows significant aliasing suppression, as well as fine structures of the salient features, which can be attributed to using both the SiLU activation function and residual skip connections.

In accordance with one or more embodiments, embodiment disclosed herein build and make use of a simulator that synthesizes mmWave radar data cubes from 2D reflectivity distributions. The first step in the simulator is the creation of realistic outdoor and indoor reflectivity distributions, which requires knowledge about the placement and radar cross section of each reflector. LiDAR point clouds of outdoor and indoor scenes are used to synthesize realistic reflectivity distributions. For each point in the LiDAR point cloud, within the FoV of the radar, the LiDAR point's cartesian coordinates are used for the location of the reflector and scaling of the LiDAR point's intensity as a proxy for the reflector's radar cross section. All points are collapsed to the same height as the radar to create a 2D reflectivity distribution, which is used as the ground truth reflectivity image. Next, the synthesized reflectivity distribution as a point reflector model in polar coordinates is modeled and the MIMO radar forward model (EQ. 1) is used to create a synthetized full radar data cube (304).

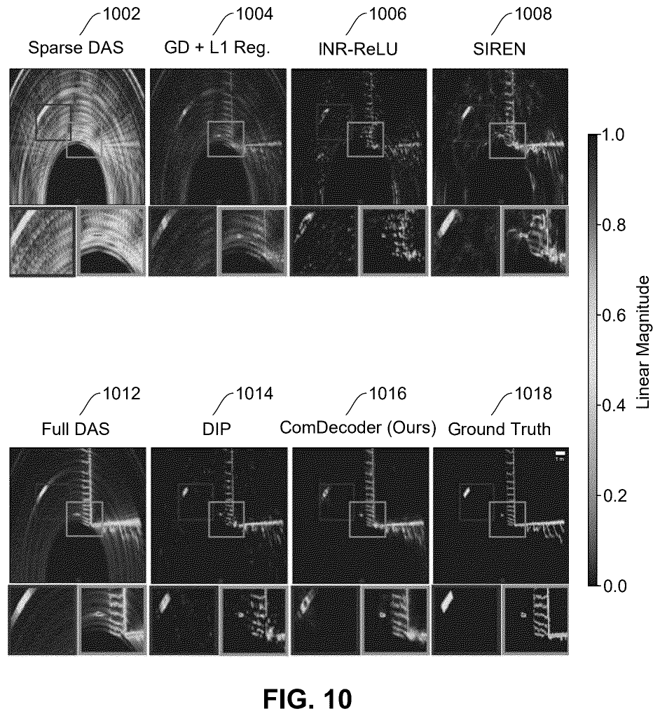

FIG. 10 shows reconstructions of two simulated scenes for all methods (1002, 1004, 1006, 1008, 1012, 1014, 1016) at a signal-to-noise ratio (SNR) of 19 dB. All iterative methods are optimized for 2000 iterations until convergence using an ADAM optimizer. The learning rates for each iterative method are chosen to provide the best performance for the given method while stabilizing the optimization. Learning rates of 8e-3 worked well for CNN-based methods, 1e-3 for the INR-ReLU method, and 1e-4 for SIREN. In all simulated experiments, the transmit bandwidth is fixed to 1.283 GHZ, carrier frequency set to 77 GHz, and the sparse aperture design proposed in FIG. 2A is used. The last column (1018) in the second row of FIG. 10 depicts the GT obtained using the Full DAS reconstruction.

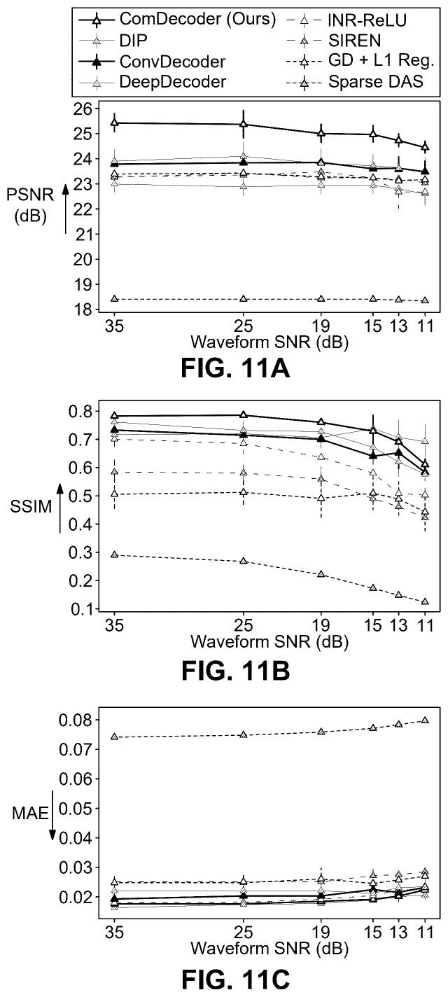

All methods (1002, 1004, 1006, 1008, 1012, 1014, 1016) qualitatively achieve improved reconstructions compared to Sparse DAS (1002), which uses no regularization. However, the methods and systems disclosed herein (1016) demonstrate a significant improvement in reconstructing extended reflectors and removing aliasing artifacts that appear as a radial blurring of energy in the other images. The observed increase in performance for the methods and systems disclosed herein (1016) over competing methods aligns with the quantitative metrics shown below in FIGS. 11A-11C. The MLP-based methods, INR-ReLU (1006) and SIREN (1008), struggle at differentiating and suppressing the structured aliasing artifacts from the underlying features in the scene, such as the wall corner in FIG. 10. The L1-norm regularized gradient descent method (1004) is able to localize the dominate reflectors in the scene but fails to remove aliasing artifacts to the level of neural-network-based methods.

FIGS. 11A-11C show the performance of each sparse radar imaging method quantified under varying noise levels added to the synthetized full radar data cube (304). The peak signal-to-noise ratio (PSNR), structural similarity index (SSIM), and mean absolute error (MAE) are used to measure the difference between the reconstructed and ground truth images. In FIGS. 11A-11C, the measurement noise is swept between 35 dB and 11 dB and averaged over 25 samples from the simulated data set.

FIG. 11A demonstrates that the methods and systems disclosed herein significantly outperform competing methods with respect to PSNR across all noise levels. In addition, the methods and systems disclosed herein achieve superior performance in the SSIM metric up to 15 dB SNR, where it achieves comparable performance to DeepDecoder, as shown in FIG. 11B. The MAE metric shows that the methods and systems disclosed herein achieve a similar level of performance as DIP, as shown in FIG. 11C. Across all metrics, as shown in FIGS. 11A-11C, DIP performs second best, which is consistent with high performance on challenging inverse problems. The remaining CNN architectures ConvDecoder and DeepDecoder perform the next best, followed by the MLP-based architectures INR-ReLU and SIREN. All methods outperform Sparse DAS, suggesting that regularization helps reduce aliasing artifacts and capture the underlying salient features in the reflectivity distributions.

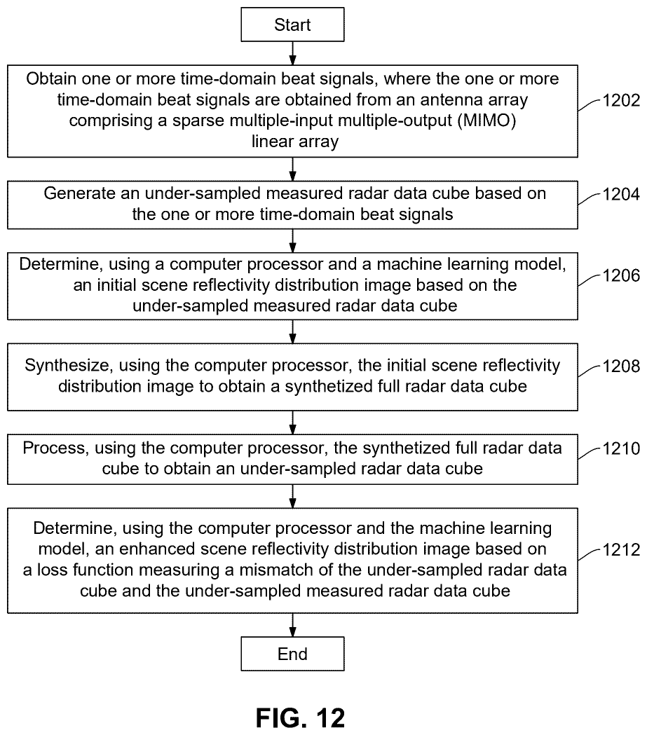

FIG. 12 depicts a method for reconstructing a scene reflectivity distribution image from an under-sampled radar measurement. In Block 1202, a transmitter array (102) illuminates a scene with a mmWave FMCW pulse. Objects (104) in the scene reflect some of the incident mmWave energy back to a receive array (106). Each antenna in the receive array (106) measures a time domain beat signal (108). A time domain beat signal (108) is the result of mixing the transmitted signal (i.e., the FMCW pulse) with the echo received from the objects (104). After mixing the received signal at each antenna with the transmitted signal (or, in some cases, a local reference) each element of the receive array (106) outputs a beat signal.

In Block 1204, each time domain beat signal (108) is used to generate an under-sampled measured radar data cube (110). Specifically, each time domain beat signal (108) corresponds to a single row of the under-sampled measured radar data cube (110).

In Block 1206, the under-sampled measured radar data cube (110) is inputted into the ML model (300) and the ML model (300) outputs a scene reflectivity distribution image (302). The scene reflectivity distribution image (302) is a complex-valued polar image of the scene's reflectivity distribution. The magnitude of the scene reflectivity distribution image (302) is typically used to visualize the reflectivity distribution.

Keeping with Block 1206, in accordance with one or more embodiments, the ML model (300) discussed herein is a CNN decoder. The CNN decoder (300) architecture includes an input (400), an upsampling layer (402), a residual block (404), and a final layer (406). Each layer except the last layer is composed of an upsampling layer (402) followed by a residual block (404). The residual block (404) includes a convolutional layer (408), a batch normalization layer (410), and an activation function (412). In accordance with one or more embodiments, when fitting the network to a given under-sampled measurement, only the parameters in the convolutional layer (408) and batch normalization layer (410) are optimized. In one or more embodiments, the activation function (412) comprises a Sigmoid Linear Unit (SiLU) activation function. The final layer (406) excludes upsampling and linearly combines the hidden channels to two output channels using a 1×1 convolutional layer. In accordance with one or more embodiments, the ML model (300) architecture described herein consists of 6 layers (including the last layer) with 128 channels per layer, and a fixed input drawn from a uniform distribution. The network weights are updated by optimizing EQ. 4 and backpropagating the loss.

In Block 1208, using a 2D FFT, the scene reflectivity distribution image (302) is synthesized to obtain a synthetized full radar data cube (304).

In Block 1210, an under-sampled representation of the synthetized full radar data cube (304) is obtained by multiplying the synthetized full radar data cube (304) with a sampling mask (306). The sampling mask (306) is a binary mask. Multiplying the synthetized full radar data cube (304) with the sampling mask (306) sets a subset of rows in the synthetized full radar data cube (304) to zero, and only the rows of the synthetized full radar data cube (304) corresponding to the sparse receive array (106) antenna locations are retained. The result is an under-sampled radar data cube (308). In accordance with one or more embodiments, the multiplication between the synthetized full radar data cube (304) with the sampling mask (306) is performed using a Hadamard product.

In Block 1212, the under-sampled radar data cube (308) generated from the scene reflectivity distribution image (302) is compared to the under-sampled measured radar data cube (110). This comparison is performed using a loss function. The goal is to alter the edge (504) values to promote similarity between the ML model (300) output (i.e., the under-sampled radar data cube (308)) and the under-sampled measured radar data cube (110). Thus, the loss function (310) is used to guide changes made to the edge (504) values through backpropagation. If the ML model performance is not suitable, the ML model architecture may be altered, and the process is repeated. Once suitable performance is achieved, the process is complete (“End”), and the result is an enhanced scene reflectivity distribution image.

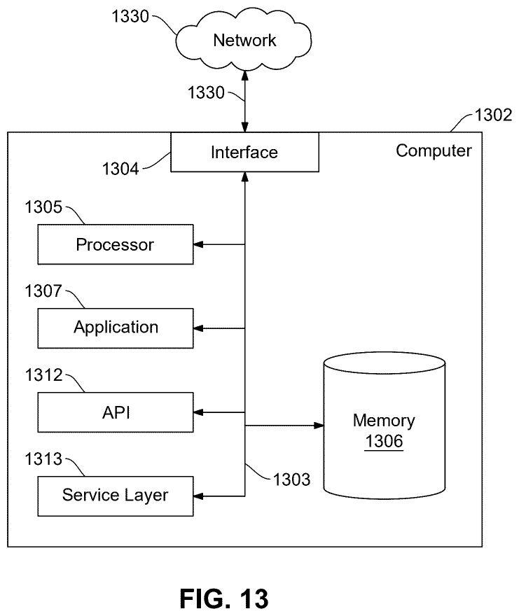

Embodiments disclosed herein may be implemented on a computer system. FIG. 13 is a block diagram of a computer system (1302) used to provide computational functionalities associated with described algorithms, methods, functions, processes, flows, and procedures as described in the instant disclosure, according to one or more embodiments. For example, in one or more embodiments, the computer system (1302) executes the FFT and synthesizes the scene reflectivity distribution image (302) to obtain a synthetized full radar data cube (304). In addition, in one or more embodiments, the computer system (1302) executes the ML model (300) and outputs an enhanced scene reflectivity distribution image (302). The illustrated computer (1302) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts.

Additionally, the computer (1302) may include a computer that includes an input device, such as a keypad, keyboard, touch screen, or other device that may accept user information, and an output device that conveys information associated with the operation of the computer (1302), including digital data, visual, or audio information (or a combination of information), or a GUI.

The computer (1302) may serve in a role as a client, network component, a server, a database or other persistency, or any other component (or a combination of roles) of a computer system for performing the subject matter described in the instant disclosure. In some implementations, one or more components of the computer (1302) may be configured to operate within environments, including cloud-computing-based, local, global, or other environment (or a combination of environments).

At a high level, the computer (1302) is an electronic computing device operable to receive, transmit, process, store, or manage data and information associated with the described subject matter. According to some implementations, the computer (1302) may also include or be communicably coupled with an application server, e-mail server, web server, caching server, streaming data server, business intelligence (BI) server, or other server (or a combination of servers).

The computer (1302) may receive requests over network (1330) from a client application (for example, executing on another computer (1302) and responding to the received requests by processing the said requests in an appropriate software application. In addition, requests may also be sent to the computer (1302) from internal users (for example, from a command console or by other appropriate access method), external or third-parties, other automated applications, as well as any other appropriate entities, individuals, systems, or computers.

Each of the components of the computer (1302) may communicate using a system bus (1303). In some implementations, any or all of the components of the computer (1302), both hardware or software (or a combination of hardware and software), may interface with each other or the interface (1304) (or a combination of both) over the system bus (1303) using an application programming interface (API) (1312) or a service layer (1313) (or a combination of the API (1312) and service layer (1313). The API (1312) may include specifications for routines, data structures, and object classes. The API (1312) may be either computer-language independent or dependent and refer to a complete interface, a single function, or even a set of APIs. The service layer (1313) provides software services to the computer (1302) or other components (whether or not illustrated) that are communicably coupled to the computer (1302). The functionality of the computer (1302) may be accessible for all service consumers using this service layer. Software services, such as those provided by the service layer (1313), provide reusable, defined business functionalities through a defined interface. For example, the interface may be software written in JAVA, C++, or other suitable language providing data in extensible markup language (XML) format or another suitable format. While illustrated as an integrated component of the computer (1302), alternative implementations may illustrate the API (1312) or the service layer (1313) as stand-alone components in relation to other components of the computer (1302) or other components (whether or not illustrated) that are communicably coupled to the computer (1302). Moreover, any or all parts of the API (1312) or the service layer (1313) may be implemented as child or sub-modules of another software module, enterprise application, or hardware module without departing from the scope of this disclosure.

The computer (1302) includes an interface (1304). Although illustrated as a single interface (1304) in FIG. 13, two or more interfaces (1304) may be used according to particular needs, desires, or particular implementations of the computer (1302). The interface (1304) is used by the computer (1302) to communicate with other systems in a distributed environment that are connected to the network (1330). Generally, the interface (1304) includes logic encoded in software or hardware (or a combination of software and hardware) and operable to communicate with the network (1330). More specifically, the interface (1304) may include software supporting one or more communication protocols associated with communications such that the network (1330) or interface's hardware is operable to communicate physical signals within and outside of the illustrated computer (1302).

The computer (1302) includes at least one computer processor (1305). Although illustrated as a single computer processor (1305) in FIG. 13, two or more processors may be used according to particular needs, desires, or particular implementations of the computer (1302). Generally, the computer processor (1305) executes instructions and manipulates data to perform the operations of the computer (1302) and any algorithms, methods, functions, processes, flows, and procedures as described in the instant disclosure.

The computer (1302) also includes a memory (1306) that holds data for the computer (1302) or other components (or a combination of both) that may be connected to the network (1330). The memory may be a non-transitory computer readable medium. For example, memory (1306) may be a database storing data consistent with this disclosure. Although illustrated as a single memory (1306) in FIG. 13, two or more memories may be used according to particular needs, desires, or particular implementations of the computer (1302) and the described functionality. While memory (1306) is illustrated as an integral component of the computer (1302), in alternative implementations, memory (1306) may be external to the computer (1302).

The application (1307) is an algorithmic software engine providing functionality according to particular needs, desires, or particular implementations of the computer (1302), particularly with respect to functionality described in this disclosure. For example, application (1307) may serve as one or more components, modules, applications, etc. Further, although illustrated as a single application (1307), the application (1307) may be implemented as multiple applications (1307) on the computer (1302). In addition, although illustrated as integral to the computer (1302), in alternative implementations, the application (1307) may be external to the computer (1302).

There may be any number of computers (1302) associated with, or external to, a computer system containing computer (1302), wherein each computer (1302) communicates over network (1330)). Further, the term “client,” “user,” and other appropriate terminology may be used interchangeably as appropriate without departing from the scope of this disclosure. Moreover, this disclosure contemplates that many users may use one computer (1302), or that one user may use multiple computers (1302).

What is claimed:

1. A method comprising:
obtaining one or more time-domain beat signals,
wherein the one or more time-domain beat signals are obtained from an antenna array comprising a sparse multiple-input multiple-output (MIMO) linear array;
generating an under-sampled measured radar data cube based on the one or more time-domain beat signals;
determining, using a computer processor and a machine learning model, an initial scene reflectivity distribution image based on the under-sampled measured radar data cube;
synthesizing, using the computer processor, the initial scene reflectivity distribution image to obtain a synthetized full radar data cube;
processing, using the computer processor, the synthetized full radar data cube to obtain an under-sampled radar data cube; and
determining, using the computer processor and the machine learning model, an enhanced scene reflectivity distribution image based on a loss function measuring a mismatch of the under-sampled radar data cube and the under-sampled measured radar data cube.

2. The method of claim 1, wherein the enhanced scene reflectivity distribution image comprises a suppressed aliasing and a suppressed noise.

3. The method of claim 1,
wherein the under-sampled measured radar data cube comprises a measured radar data cube, and
wherein the synthetized full radar data cube comprises a full-aperture Nyquist-sampled radar data cube.

4. The method of claim 1,
wherein the under-sampled measured radar data cube comprises a set of rows,
wherein generating the under-sampled measured radar data cube comprises inputting each of the one or more time-domain beat signals into a subset of the set of rows of the under-sampled measured radar data cube, and
wherein the subset of the set of rows corresponds to a location of a one or more receiver antennas of the antenna array.

5. The method of claim 1, wherein synthesizing the initial scene reflectivity distribution image comprises computing a Fast Fourier Transform (FFT) of the initial scene reflectivity distribution image.

6. The method of claim 1, wherein processing comprises:
generating a sampling mask comprising a set of binary rows; and
multiplying, using the computer processor, the synthetized full radar data cube by the sampling mask to obtain a masked under-sampled radar data cube.

7. The method of claim 6,
wherein multiplying the synthetized full radar data cube by the sampling mask comprises setting a subset of a set of rows of the synthetized full radar data cube to zero, and
wherein multiplying the synthetized full radar data cube by the sampling mask comprises a Hadamard multiplication.

8. The method of claim 6,
wherein the set of binary rows comprises a set of non-zero rows, and
wherein the set of non-zero rows corresponds to a location of a one or more receiver antennas of the antenna array.

9. The method of claim 1, further comprising:
selecting, using the computer processor, a machine learning model type and a plurality of hyperparameters, wherein the plurality of hyperparameters comprises an L1-norm hyperparameter;
evaluating, using the computer processor and the loss function, the selected machine learning model based on its predictive performance on the enhanced scene reflectivity distribution image;
adjusting, using the computer processor and the loss function, the plurality of hyperparameters; and
re-training, using the computer processor, the selected machine learning model with the adjusted plurality of hyperparameters.

10. The method of claim 1, wherein determining the initial scene reflectivity distribution image using a neural network comprises:
generating, using the computer processor, relationships between the under-sampled measured radar data cube and a target initial scene reflectivity distribution image by adjusting weights and biases of neurons in the neural network; and
determining, using the computer processor, the initial scene reflectivity distribution image based on the generated relationships.

11. The method of claim 1,
wherein the machine learning model comprises a convolutional neural network,
wherein the machine learning model comprises a Sigmoid Linear Unit (SiLU) activation function, and
wherein the convolutional neural network comprises a convolutional implicit neural representation.

12. The method of claim 1, further comprising:
applying an optimizer to the machine learning model to accelerate a convergence rate of the machine learning model,
wherein the optimizer comprises an Adam optimizer.

13. A system, comprising:
a millimeter wave imaging sensor with optical access to a scene, wherein the millimeter wave imaging sensor comprises an antenna array;
a machine learning model, wherein the machine learning model receives an under-sampled measured radar data cube and outputs an enhanced scene reflectivity distribution image; and
a computer communicably connected to the millimeter wave imaging sensor, the computer comprising a processor and a memory, the memory storing instructions that, when executed by the processor, cause the processor to:
obtain one or more time-domain beat signals,
wherein the one or more time-domain beat signals are obtained from the antenna array, and
wherein the antenna array comprises a sparse multiple-input multiple-output (MIMO) linear array;
generate the under-sampled measured radar data cube based on the one or more time-domain beat signals;
determine, using the machine learning model, an initial scene reflectivity distribution image based on the under-sampled measured radar data cube;
synthesize the initial scene reflectivity distribution image to obtain a synthetized full radar data cube;
process the synthetized full radar data cube to obtain an under-sampled radar data cube; and
determine, using the machine learning model, the enhanced scene reflectivity distribution image based on a loss function measuring a mismatch of the under-sampled radar data cube and the under-sampled measured radar data cube.

14. The system of claim 13, wherein the enhanced scene reflectivity distribution image comprises a suppressed aliasing and a suppressed noise.

15. The system of claim 13,
wherein the under-sampled measured radar data cube comprises a set of rows,
wherein generating the under-sampled measured radar data cube comprises inputting each of the one or more time-domain beat signals into a subset of the set of rows of the under-sampled measured radar data cube, and
wherein the subset of the set of rows corresponds to a location of a one or more receiver antennas of the antenna array.

16. The system of claim 13, wherein synthesizing the initial scene reflectivity distribution image comprises computing a Fast Fourier Transform (FFT) of the initial scene reflectivity distribution image.

17. The system of claim 13, wherein processing comprises:
generating a sampling mask comprising a set of binary rows; and
multiplying the synthetized full radar data cube by the sampling mask to obtain a masked under-sampled radar data cube.

18. The system of claim 17,
wherein multiplying the synthetized full radar data cube by the sampling mask comprises setting a subset of a set of rows of the synthetized full radar data cube to zero, and
wherein multiplying the synthetized full radar data cube by the sampling mask comprises a Hadamard multiplication.

19. The system of claim 13,
wherein the sparse MIMO linear array comprises a transmitter array and a receive array,
wherein the receive array comprises a four-element minimum redundant array (MRA), and
wherein the transmitter array is optimized to meet a hardware and an imaging constraint.

20. A non-transitory computer-readable medium storing instructions that, when executed by a processor, cause the processor to perform a method comprising:
obtaining one or more time-domain beat signals,
wherein the one or more time-domain beat signals are obtained from an antenna array, and
wherein the antenna array comprises a sparse multiple-input multiple-output (MIMO) linear array;
generating an under-sampled measured radar data cube based on the one or more time-domain beat signals;
determining, using a machine learning model, an initial scene reflectivity distribution image based on the under-sampled measured radar data cube;
synthesizing the initial scene reflectivity distribution image to obtain a synthetized full radar data cube;
processing the synthetized full radar data cube to obtain an under-sampled radar data cube; and
determining, using the machine learning model, an enhanced scene reflectivity distribution image based on a loss function measuring a mismatch of the under-sampled radar data cube and the under-sampled measured radar data cube.
